(19) United States
(12) Patent Application Publication
(10) Pub. No.: US 2019/0344777 A1
(43) Pub. Date: Nov. 14, 2019

(54) METHOD FOR OPTIMISING THE ENERGY CONSUMPTION OF A HYBRID VEHICLE

(71) Applicant: RENAULT s.a.s., Boulogne-Billancourt (FR)

(72) Inventors: Abdel-Djalil OURABAH, Paris (FR); Atef GAYED, Marly La Ville (FR); Benjamin QUOST, Compiegne (FR); Thierry DENOEUX, Compiegne (FR)

(73) Assignee: RENAULT s.a.s., Boulogne-Billancourt (FR)

(21) Appl. No.: 16/475,910

(22) PCT Filed: Dec. 20, 2017
(86) PCT No.: PCT/FR2017/053742

§ 371 Date: Jul. 3, 2019

(30) Foreign Application Priority Data
Jan. 5, 2017 (FR) 1750109

(51) Int. Cl. B60W 20/13; B60W 20/12; B60L 58/16

(52) U.S. Cl. CPC B60W 20/13; B60L 58/16; B60W 20/12

(57) ABSTRACT

A method for preserving the state of health of a traction battery of a hybrid motor vehicle includes: a) acquiring a journey to be made via a navigation system installed in the hybrid motor vehicle, b) dividing the journey into successive portions, c) allocating attributes characterising each of the portions, d) determining, for each of the portions, a curve or a map linking every fuel consumption value of the hybrid motor vehicle for the portion to a charge or discharge value of the traction battery, e) determining an optimal point on each curve or map that makes it possible to minimise the ageing of the traction battery over the entire journey and to ensure that the traction battery is completely discharged on completion of the journey, and f) generating an energy management setpoint depending on the coordinates of the optimal points.

### TECHNICAL FIELD OF THE INVENTION

The present invention relates in general to rechargeable hybrid vehicles.

It relates more particularly to a method for optimizing the energy consumption of a hybrid vehicle comprising an internal combustion engine supplied with fuel and an electric engine supplied by a traction battery. The invention is applied to particular advantage in hybrid vehicles having great electrical autonomy, that is to say in vehicles able to travel for a distance greater than ten kilometers using just their electric engine.

### TECHNOLOGICAL BACKGROUND

A rechargeable hybrid vehicle includes a conventional thermal traction chain comprising an internal combustion engine and a fuel tank, and an electric traction chain comprising an electric engine and a traction battery, which is in particular able to be charged from a power outlet.

Such a hybrid vehicle is able to be driven by its electric traction chain alone, or by its thermal traction chain alone, or else at the same time by its two electric and thermal traction chains, which corresponds to a hybrid mode of operation of the vehicle. The choice to use just one or both traction chains at the same time is made by an energy management system (EMS).

Due to the fact that the future route of the vehicle is unknown, the strategy currently implemented to use one or the other of the traction chains consists in systematically starting by discharging the traction battery at the start of the route until a minimum energy level is reached, and in then using the thermal traction chain. In this way, when the driver takes short routes and when he regularly has the option of recharging the traction battery, he uses the electric traction chain as much as possible, thereby reducing the polluting emissions of the vehicle.

Therefore, energy management systems implement what is known as a “discharge-hold” strategy, involving giving priority to completely discharging the traction battery without taking into account the nature and the topography of the route. Thus, the “discharge-hold” strategy involves burdens on the traction battery that may be extreme and liable to prematurely alter the performance of said battery.

Specifically, the traction battery is intended to operate over a defined state of energy (SOE) range, which differs according to the intrinsic characteristics of the battery. For example, for a lithium-ion battery, which is the one most commonly used in electric and hybrid vehicles, this operating range generally lies between 15% and 95% of the state of energy range. It is defined by drawing a compromise between the usable capacity and the lifetime of the battery. There are many factors that degrade the performance of the battery and reduce its capacity, such as temperature, a high current intensity for a prolonged duration, overvoltage, undervoltage, etc.

In this respect, document FR2995859 discloses an energy management system for limiting the ageing of the traction battery. To this end, this document proposes an energy management system that expands the usage range of the battery in hybrid mode when the battery ages.

However, this solution has the drawback of being applied independently of the distance to be covered by the vehicle. The vehicle may thus be operated in hybrid mode along the entire route, whereas the autonomy of the traction battery would have allowed it to take the whole route without consuming gasoline.

In another drawback, the optimum usage range is predefined in advance and does not take into account the running profile on the route. The energy management system may thus impose charging or discharging setpoints that bring about premature ageing of the traction battery when the running conditions are not favorable to use thereof.

### SUBJECT OF THE INVENTION

To rectify the abovementioned drawbacks from the prior art, the present invention proposes a method for optimizing the energy consumption of a hybrid vehicle as defined in the introduction, which comprises the following steps:

a) acquiring, by way of a navigation system, a route to be taken;

b) dividing said route into successive sections;

c) acquiring, for each section, attributes characterizing said section;

d) for each of said sections, and taking into account its attributes, selecting, from among a plurality of predetermined relationships linking fuel consumption values with electrical energy consumption values, a relationship linking the fuel consumption of the hybrid motor vehicle over the section to its electrical energy consumption;

e) determining an optimum point for preserving the state of health of the traction battery in each of the selected relationships, such that all of the optimum points minimize the ageing of the traction battery over the entire route and maximize the discharge of the traction battery at the end of said route; and

f) formulating a setpoint for managing the fuel consumption and electric current consumption of the motor vehicle, along the entire route, as a function of the coordinates of said optimum points.

Thus, by virtue of the invention, it is possible to determine the times at which the electric engine should rather be used or the internal combustion engine should rather be used, so as to optimally reduce the ageing of the traction battery over the route taken by the hybrid vehicle. More precisely, the invention makes it possible to give priority to use of the traction battery in an optimum and restricted operating range, taking into account the nature and the topography of the route. The traction battery is thus used in conditions that are more respectful to its state of health, that is to say in an electric voltage range allowing it to deliver a current intensity that is neither too high nor too low. Advantageously, the invention therefore makes it possible to increase the lifetime of the traction battery, thus limiting the maintenance costs for a hybrid motor vehicle, by avoiding early replacement of the traction battery.

According to another feature of the invention, in step e), the determination of an optimum point in each of the relationships selected for each section depends on the fuel consumption over the entire section, weighted by a preservation relationship for preserving the state of health of the traction battery. In other words, the weighting relationship makes it possible to give priority to operation of the electric engine when the traction battery is in its optimum usage range. By contrast, when the charge of the traction battery is less than or greater than this optimum state of charge, the weighting relationship gives priority to use of the thermal combustion engine so as to reduce the burdens exerted by the electric engine on the traction battery. It should nevertheless be noted that the weighting relationship does not prevent use of the traction battery outside of its optimum usage range.

Other advantageous and nonlimiting features of the method for preserving the state of health of a traction battery according to the invention are as follows:
the value of the preservation relationship decreases when the state of energy of the traction battery is within an optimum usage range, such that the management setpoint gives priority to use of the traction battery in its optimum usage range during the route;
the value of the preservation relationship decreases when the distance to be covered to the destination increases, preferably when the maximum electrical autonomy of the vehicle decreases and is less than the remaining distance for it to cover to arrive at the destination, the management setpoint gives priority to use of the electric engine so as to discharge the traction battery at the end of the route;
the preservation relationship depends on a product of an activation function and a weighting function, the value of the activation function being at a minimum when the maximum electrical autonomy of the vehicle may be for example less than twice the remaining distance for it to cover to arrive at the destination, so as to minimize the influence of the preservation relationship in the determination of an optimum point for preserving the state of health of the traction battery in each of the selected relationships;
the preservation relationship depends on a product of an activation function and a weighting function, the value of the weighting function being at a minimum when the state of energy of the traction battery is outside of its optimum usage range, so as to minimize the influence of the preservation relationship in the determination of the optimum point, the preservation relationship preferably tends towards value 1;
the value of the activation function is at a maximum when the distance to be covered to arrive at the destination decreases, preferably the value of the activation function is at a maximum when the maximum electrical autonomy of the vehicle is less than eight times the remaining distance for it to cover to arrive at the destination, so as to allow complete discharging of the traction battery at the end of the route;
the activation function may be at a maximum when the maximum electrical autonomy of the hybrid vehicle is less than the remaining distance to be covered by the vehicle;
the activation function may be greater than twice or preferably greater than six times the maximum electrical autonomy of the vehicle;
the value of the activation function varies linearly between its minimum value and its maximum value;
the value of the weighting function is at a maximum when the state of energy of the traction battery is in the center of its optimum usage range, such that the management setpoint gives priority to use of the electric engine when its traction battery is operating in its optimum usage range; the value of the weighting function varies symmetrically on either side of the center of the optimum usage range of the traction battery;
for example, the weighting function may have a maximum value over more than 10% of the optimum usage range of the traction battery, preferably over more than 50%;
the optimum usage range of the traction battery is between 60% and 80% of its maximum charge;
the preservation relationship comprises a maximum weighting value, so as to control the amplitude of the variation of the value of the preservation relationship;
the maximum weighting value is preferably constant and between 0.1 and 1;
the preservation relationship is proportional to a product of the activation function, the weighting function and the maximum weighting value.

### DETAILED DESCRIPTION OF ONE EXEMPLARY EMBODIMENT

The description that follows with reference to the appended drawings, which are given by way of non-limiting example, will make it easy to understand what the invention consists of and how it may be implemented.

In the appended drawings:

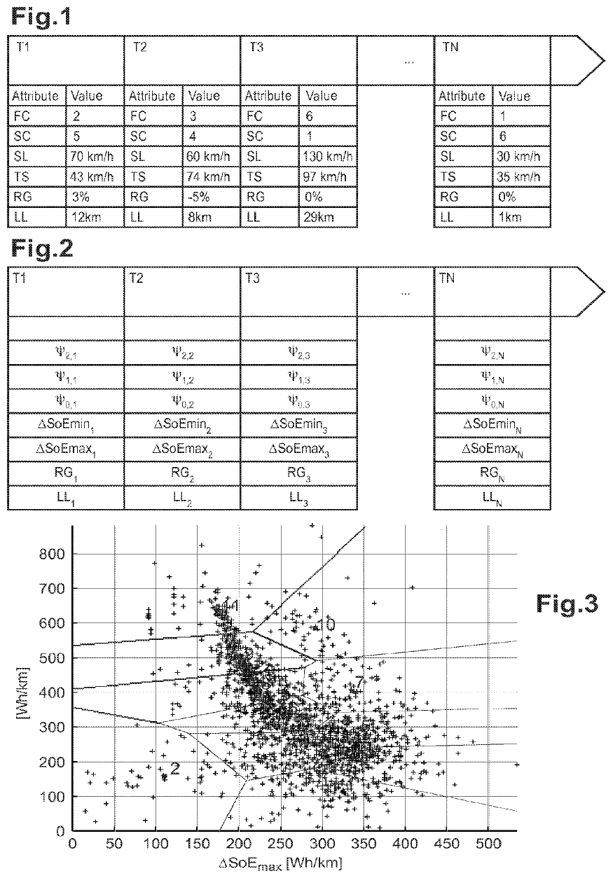

FIG. 1 is a table illustrating the values of attributes characterizing sections of a route that a vehicle has to take;

FIG. 2 is a table illustrating the parameters of reference curves characterizing the sections of the route to be taken;

FIG. 3 is a graph illustrating the distribution of specific consumption curves acquired in test runs;

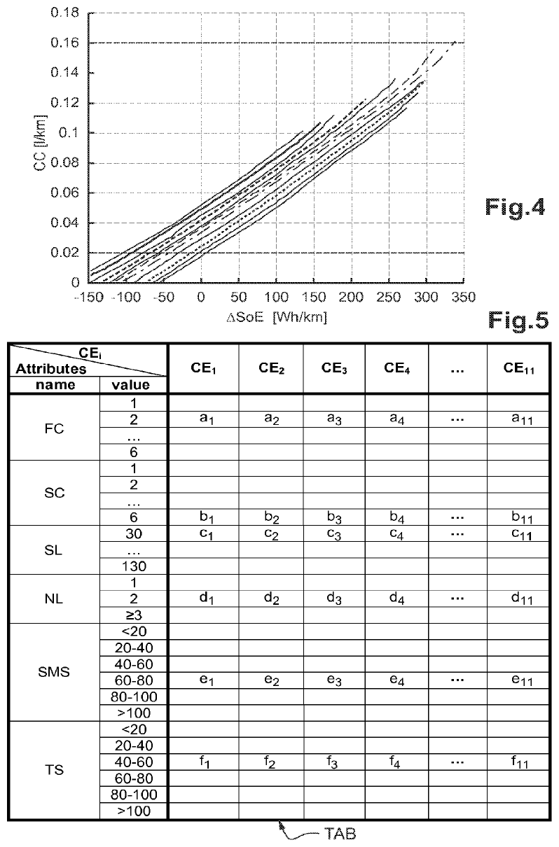

FIG. 4 is a graph illustrating a plurality of reference curves;

FIG. 5 is a table associating, with each attribute value assigned to a section, a probability of this section being associated with one or the other of the reference curves of FIG. 4;

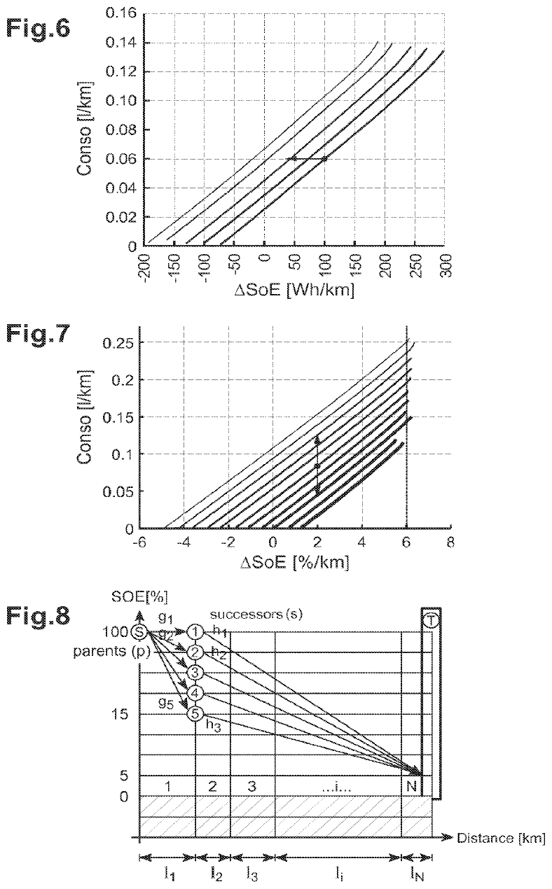

FIG. 6 is a graph illustrating the corrections to be made to a reference curve, taking into account the electrical consumption of auxiliary devices of the vehicle;

FIG. 7 is a graph illustrating the corrections to be made to a reference curve, taking into account the slope of the section of the corresponding route;

FIG. 8 is a graph illustrating an example of a calculation step of an algorithm for searching for the optimum trajectory using an optimization algorithm;

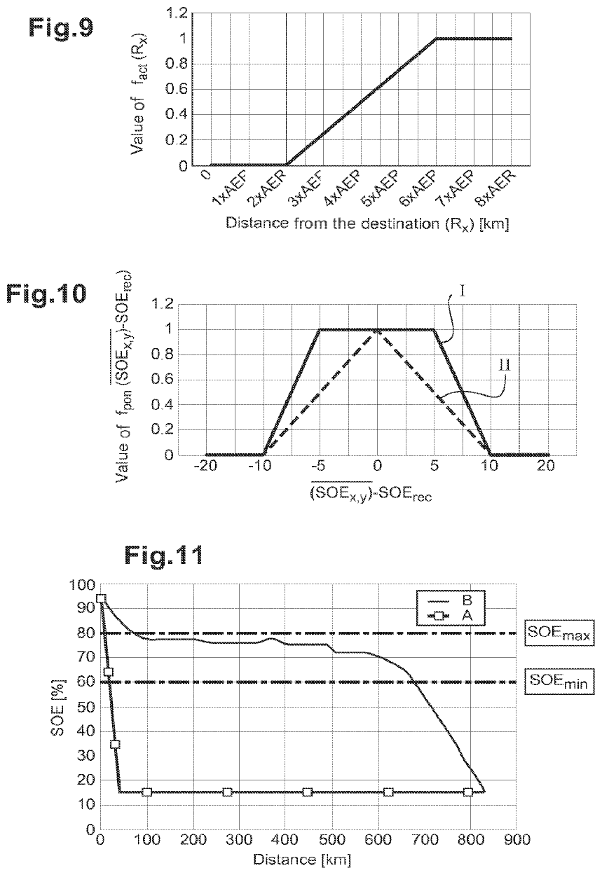

FIG. 9 is a graph illustrating an example of a form of an activation function according to the invention;

FIG. 10 is a graph illustrating two examples of forms of a weighting function according to the invention;

FIG. 11 is a graph illustrating an example of the variation of the state of energy of a traction battery on a route greater than its maximum electrical autonomy using a method according to the invention (curve A) and using a discharge-hold method (curve B).

A motor vehicle conventionally includes a chassis that in particular supports a drivetrain, bodywork elements and passenger compartment elements.

In a rechargeable hybrid vehicle, the drivetrain includes a thermal traction chain and an electric traction chain.

The thermal traction chain includes in particular a fuel tank and an internal combustion engine supplied with fuel from the tank.

The electric traction chain, for its part, includes a traction battery and one or more electric engines supplied with electric current by the traction battery.

The motor vehicle in this case also includes a power socket allowing the traction battery to be charged locally, for example on the electricity grid of a home or on any other electricity grid.

The motor vehicle also includes auxiliary devices, which are defined here as electrical devices supplied with current by the traction battery.

Among these auxiliary devices, mention may be made of the air conditioning motor, the electric window motors, or else the geolocation and navigation system.

This geolocation and navigation system conventionally includes an antenna for receiving signals in relation to the geolocated position of the motor vehicle, a memory for storing a map of a country or of a region, and a screen for illustrating the position of the vehicle on this map.

In this case, consideration is given to the case in which this screen is a touchscreen, allowing the driver to input information thereon. It could of course be a different screen.

Lastly, the geolocation and navigation system includes a controller for calculating a route to be taken, taking into account information input by the driver, the map stored in its memory, and the position of the motor vehicle.

The motor vehicle 1 moreover comprises an electronic control unit (ECU), in this case called a computer, in particular for controlling the abovementioned two traction chains (in particular the powers created by the electric engine and by the internal combustion engine).

In the context of the present invention, this computer is connected to the controller of the geolocation and navigation system, such that these two elements are able to communicate information.

In this case, they are connected together by the main inter-unit communication network of the vehicle (typically by the CAN bus).

The computer comprises a processor and a storage unit (called memory hereinafter).

This memory stores data used in the context of the method described below.

It stores in particular a table of the type illustrated in FIG. 5 (which will be described in the remainder of this disclosure).

It also stores a computer application, formed of computer programs comprising instructions the execution of which by the processor allows the computer to implement the method described hereinafter.

By way of introduction, a definition will be given here of several concepts used in the disclosure of the method described hereinafter.

The term “route” may thus be defined as being a path that the motor vehicle has to take from a starting station in order to reach an arrival station.

This arrival station, the destination of the route, will be considered to be equipped with a charging station for recharging the traction battery via the power socket with which the vehicle is equipped.

Each route may be divided into “adjacent segments” and into “adjacent sections”.

The concept of segments will be used natively by the controller with which the geolocation and navigation system is equipped.

In practice, each segment may correspond for example to a portion of the route that extends between two road intersections. To define the shortest or fastest route, the controller will therefore determine the road segments through which the route should pass.

The concept of sections is different. It will be described in detail in the remainder of this disclosure. To simplify, each section of the route corresponds to a portion of the route on which the features of the road do not change substantially. By way of example, the route could thus be divided into several sections on each of which the maximum permitted speed limit is constant.

These sections are characterized by parameters that are called “attributes” here. Examples of attributes for characterizing each section are as follows.

A first attribute will be the “road category FC”. The controllers with which geolocation and navigation systems are equipped generally use this type of category to distinguish between various types of road. In this case, this category may take an integer value of between 1 and 6 for example. An attribute equal to 1 could correspond to an expressway, an attribute equal to 2 could correspond to a highway, etc.

A second attribute will be the “slope RG” of the section, expressed in degrees or as a percentage.

The third, fourth, fifth and sixth attributes will relate to characteristic speeds of the vehicles traveling on the section.

The third attribute will be the “speed category SC” of the section. The controllers with which geolocation and navigation systems are equipped generally also use this type of category to distinguish between various types of road. In this case, this category may take an integer value of between 1 and 6 for example. An attribute equal to 1 may correspond to a very high-speed road (higher than 120 km/h), an attribute equal to 2 may correspond to a high-speed road (between 100 and 120 km/h), etc.

The fourth attribute will be the “permitted speed limit SL” over the section.

The fifth attribute will be the “average speed SMS” observed over the section (the value of which results from a statistical measurement performed on each road).

The sixth attribute will be the “instantaneous speed TS” observed over the section (the value of which results from an information system regarding the real-time state of the traffic).

The seventh attribute will be the “length LL” of the section.

The eighth attribute will be the “average radius of curvature LC” of the section.

The ninth attribute will be the “number of lanes NL” of the section in the travel direction taken by the vehicle.

In the following disclosure, these nine attributes will be used to characterize each section of the route.

As a variant, each section of the route may be characterized by a smaller or greater number of attributes.

The state of energy (SOE) of the traction battery will moreover be defined as being a parameter for characterizing the remaining energy in this traction battery. As a variant, another parameter such as the state of charge SOC of the battery or any other parameter of the same type (internal resistance of the battery, voltage across the terminals of the battery, etc.) may be used.

The charge or the discharge ΔSOE of the traction battery will then be considered to be equal to the difference between two states of energy considered at two separate times.

The “specific consumption curve” of the vehicle on a section under consideration is then defined as being a curve that associates, with each fuel consumption value CC of the vehicle, a charge or discharge value ΔSOE of the traction battery. Specifically, over a given section, it is possible to estimate what the fuel consumption CC of the vehicle will be (in liters per kilometer covered) and what the charge or discharge ΔSOE of the traction battery will be (in watt-hours per kilometer). These two values will be linked by a curve, since they will vary depending on whether rather the electric traction chain or rather the thermal traction chain is used to drive the vehicle.

Since there are an infinite number of specific consumption curves, the “reference curves” are lastly defined as being particular specific consumption curves whose characteristics will be well known and that will make it possible to approximate each specific consumption curve. In other words, as will become more apparent in the remainder of this disclosure, there will be associated, with each route section, not a specific consumption curve but rather a reference curve (the one which will form the best approximation of the specific consumption curve).

The method, which is implemented jointly by the controller of the geolocation and navigation system and by the computer of the vehicle, is a method for calculating a setpoint for managing the fuel consumption and electric current consumption of the vehicle.

This method consists more precisely in determining how, on a predefined route, the electric traction chain and the thermal traction chain should be used so as to optimally preserve the state of health of the traction battery.

According to one particularly advantageous feature of the invention, the method comprises the following six main steps:
acquiring a route to be taken,
dividing said route into successive adjacent sections Tᵢ,
acquiring, for each section Tᵢ, attributes FC, SC, SL, TS, RG, LL NL, SMS characterizing this section
determining, for each of the sections Tᵢ, taking into account the attributes FC, SC, SL, TS, RG, LL NL, SMS of this section Tᵢ, a relationship (called reference curve CEⱼ here) linking each fuel consumption value CC of the hybrid motor vehicle over the section with a charge or discharge value ΔSOE of the traction battery,
determining an optimum point Pᵢ of each reference curve CEⱼ for optimally preserving the state of health SOH of the traction battery and achieving complete discharging of the traction battery at the end of said route, and
formulating an energy management setpoint as a function of the coordinates of said optimum points Pᵢ.

It will be recalled at this juncture that, throughout its lifetime, a battery exhibits performance that tends to deteriorate gradually due to irreversible chemical changes that take place during use. This deterioration is quantified using an indicator called “state of health SOH”, which defines the ability of the battery to provide specific capabilities, in comparison with the capabilities that it was capable of providing in the new state. As is well known, this state of health SOH exhibits a very high correlation with the internal resistance of the battery and with the voltage across its terminals (in the charged state).

These six successive steps are described in the remainder of this disclosure.

The first step consists in acquiring the route that the motor vehicle is to take.

This step may be performed by the controller embedded in the geolocation and navigation system.

This step is then implemented in a conventional manner.

Thus, when the driver uses the touchscreen of the geolocation and navigation system to define an arrival station, the controller of this system calculates the route to be taken, in particular depending on journey parameters selected by the driver (fastest route, shortest route, etc.).

At this stage, it may be noted that the method will have to be reset as soon as the vehicle takes a route different from the one defined by the geolocation and navigation system.

As a variant, this first step may be performed differently.

Thus, it will be possible to dispense with the driver inputting the arrival station on the touchscreen. To this end, the controller may detect the driver's routines and automatically deduce the arrival station therefrom.

For example, when the driver takes the same route every day of the week to go to work, this route may be acquired automatically without the driver having input any information on the touchscreen of the geolocation and navigation system.

At the end of this first step, the controller embedded in the geolocation and navigation system knows the route of the vehicle, which is then formed of a plurality of adjacent segments which, as it is recalled, each extend between two road intersections.

The second step consists in dividing the route into sections Tᵢ.

The benefit of re-dividing the route not into segments but into sections is first of all that of reducing the number of subdivisions of the route. Specifically, it is often the case that the attributes of two successive segments are identical. If these two successive segments were to be processed separately, the duration of the calculations would be needlessly multiplied. By combining the identical segments within one and the same section, it will be possible to reduce the duration of the calculations.

Another benefit is that the features of the road over one and the same segment may vary substantially (one portion of the segment may correspond to a road with no slope and another portion of this segment may correspond to a road with a large slope). In this case, it is desired to divide the route into sections over each of which the features of the road remain homogeneous.

Each section Tᵢ will be defined here as being a portion of the route that contains at least one attribute that does not vary over its entire length.

This attribute may consist of the slope RG and/or the speed category SC and/or the road category FC.

In this case, this step will be implemented by the controller embedded in the geolocation and navigation system. To this end, it will divide the route into sections Tᵢ of maximum length over which the abovementioned three attributes (RG, SC, FC) are constant.

At the end of this second step, the controller has thus defined N sections.

The third step consists in acquiring the attributes of each section Tᵢ.

When one of the attributes is variable over the section under consideration, it is the average value of this attribute over the entire section that will be considered.

In practice, this third step is performed as follows.

First of all, the controller embedded in the geolocation and navigation system informs the computer that a new route has been calculated. The computer then requests sending of the attributes of each section, in the form for example of a table of the type illustrated in FIG. 1.

The controller then acquires the attributes of each section as follows.

It calculates a portion, in particular the length LL of the section.

It reads another portion thereof from the memory of the geolocation and navigation system, in particular the road category FC, the slope RG, the speed category SC, the permitted speed limit SL, the average speed SMS, the average radius of curvature LC and the number of lanes NL.

A last portion of these attributes is communicated to it by another device, in particular the instantaneous speed TS, which is communicated to it by the information system on the real-time state of the traffic.

The controller then transmits all of this information to the main computer of the vehicle via the CAN bus.

The advantage of using the controller embedded in the geolocation and navigation system rather than the main computer of the vehicle to perform the three first steps is that of reducing the amount of information to be transmitted to the computer by the CAN bus. Specifically, by merging the adjacent segments of the route that have the same attributes, the volume of data transmitted is reduced, thereby speeding up the transmission of the data by the CAN bus.

Upon reception of the information, the computer implements the following steps.

The fourth step then consists, for each of the segments Tᵢ, in determining, from among the reference curves CEⱼ stored in the memory of the computer, the one that will allow optimum estimation of the energy consumption (fuel consumption and current consumption) of the vehicle over the section Tᵢ under consideration.

This step then makes it possible to move from characterization of each section in terms of attributes to characterization in terms of energy cost.

During this fourth step of the present exemplary embodiment, the computer will use the table TAB illustrated in FIG. 5, which is stored in its memory.

As shown in FIG. 5, this table TAB has rows that each correspond to a value (or to an interval of values) of an attribute. It has columns each corresponding to one of the reference curves CEⱼ. In the example illustrated, it will be considered that the memory of the computer stores M reference curves CEⱼ, where M is in this case equal to eleven.

In FIG. 5, the cells of the table TAB are left empty, since the values that they will contain will depend on the features of the vehicle.

In practice, this table TAB will be stored in the memory of the computer with values in each of these cells.

These values will be probability values (between 0 and 1) corresponding to the probability of each attribute value corresponding to one or the other of the reference curves CEⱼ.

By way of example, if the road category FC of a section Tᵢ has a value equal to 2, it may be read from the table that the probability of this section being correctly characterized in terms of energy cost by the reference curve CE1 will be equal to a₁, that the probability of this section being correctly characterized in terms of energy cost by the reference curve CE2 will be equal to a₂, etc.

It will be noted that the values of the slopes RG and length LL have intentionally not been used in this table TAB.

At this stage, the computer may then note each probability value corresponding to the value of each attribute of the section Tᵢ under consideration.

In the example illustrated, in which it is considered that the attribute FC is equal to 2, that the attribute SC is equal to 6, that the attribute SL is equal to 30, that the attribute NL is equal to 2, that the attribute SMS is between 60 and 80 and that the attribute TS is between 40 and 60, the computer notes the values denoted a₁ to a₁₁, b₁ to b₁₁, c₁ to c₁₁, d₁ to d₁₁, e₁ to e₁₁, and f₁ to f₁₁.

The computer then takes the sum of the probabilities of the section Tᵢ under consideration being correctly characterized in terms of energy cost by each of the eleven reference curves CEⱼ.

In the example illustrated, the computer to this end sums the values denoted a₁ to f₁, and then a₂ to f₂, etc.

Lastly, the computer determines which of the eleven sums gives the highest result.

It then considers that the reference curve CEⱼ with which this high probability sum is associated is the one that best characterizes the section Tᵢ in terms of energy cost.

The computer may then acquire, from its memory, the parameter values characterizing this reference curve CEⱼ.

At this stage of the disclosure, what may more precisely be of interest is the way in which these reference curves are obtained and modeled.

For each vehicle model (or for each engine model, or for each set of automobile models, or for each set of engine models), it is necessary to perform a large number of test runs (or test run simulations) on various geolocated road sections.

These test runs make it possible to determine the fuel consumption and electric current consumption of the vehicle on various sections whose attributes are known. To this end, the vehicle is moved over each section several times, increasing the proportion of the traction provided by the electric engine each time.

It is then possible to generate a specific consumption curve SCC for each section. These specific consumption curves are of the type of curves illustrated in FIG. 4.

It may be observed on each of these curves that the more electrical energy is used (that is to say ΔSOE<0), the more the fuel consumption drops, until reaching 0 in a run using exclusively the electric traction chain. By contrast, the more it is sought to recharge the battery via the thermal combustion engine (ΔSOE>0), the more the fuel consumption increases. Lastly, it will be recalled that each specific consumption curve SCC describes the average energy consumption of the vehicle for the situation of a run on a horizontal road (no slope), without electrical consumption from the auxiliary devices.

These test runs make it possible to find as many specific consumption curves SCC as there are sections tested.

Each specific consumption curve SCC may be modeled by a second-order polynomial for which the charge and discharge variations ΔSOE of the traction battery are bounded between a minimum threshold ΔSOEₘᵢₙ and a maximum threshold ΔSOEₘₐₓ, which may be written as follows:

$$\{ \begin{matrix}{m}_{FC} = {Ψ}_{2} \cdot {Δ SOE}^{2} + {Ψ}_{1} \cdot Δ SOE + {Ψ}_{0} \\ Δ SOE ∈ [ \begin{matrix}Δ SOE min & Δ SOE max\end{matrix} ]\end{matrix} \qquad [ 1 ]$$

where ψ₀, ψ₁, ω₂ are the coefficients of the polynomial.

As shown by the curves in FIG. 4, to simplify this model, it may be estimated that the two coefficients ψᵢ, ψ₂ are identical from one curve to another. It may also be observed that the minimum threshold ΔSOEₘᵢₙ depends on the three coefficients of the polynomial. Thus, only the coefficient ψ₀ and the maximum threshold ΔSOEₘₐₓ vary. It is therefore these two values that make it possible to characterize each specific consumption curve SCC.

FIG. 3 illustrates, through an example, points whose coordinates correspond to these two variables ψ₀ and ΔSOEₘₐₓ. It shows the distribution of the specific consumption curves SCC obtained during the test runs that were performed. It is considered here that these points are distributed into eleven separate zones. Each zone is then defined by its barycenter.

Thus, as has been explained above, in the method, the specific consumption curve that would correspond exactly to the section under consideration is not acquired, but consideration is given rather to one of the eleven reference curves whose variables ψ₀ and ΔSOEₘₐₓ correspond to the barycenter of one of these eleven zones.

At this stage of the method, each section Tᵢ is then defined, as shown by FIG. 2, by the abovementioned parameters ψ₀, ψ₁, ψ₂, ΔSOEₘᵢₙ, ΔSOEₘₐₓ and by the length LLᵢ of each section Tᵢ and by its slope RGᵢ.

As has been explained above, the energy curve CE; that is selected does not take into account the slope of the section Tᵢ or the electric current consumption of the auxiliary devices (air conditioning motor, etc.).

To take into account the slope of each section Tᵢ, a step of correcting each reference curve CEᵢ as a function of the slope RGᵢ is provided.

As shown clearly in FIG. 7, this correction step consists simply in shifting the reference curve CE; associated with the section Tᵢ upward or downward (that is to say constant charging or discharging ΔSOE), by a value dependent on the slope RGᵢ.

Specifically, it is understood that when the road section under consideration goes uphill, the fuel consumption will be higher than that initially predicted. By contrast, when the road section under consideration goes downhill, the fuel consumption will be lower than that initially predicted.

Furthermore, during braking phases, it will be possible to recover more electrical energy when going downhill than when going uphill.

In practice, the correction step will consist in correcting the parameter ψ₀ using the following formula:

ψ₀′=ψ₀+K·RGi [2]

where K is a coefficient in the value that depends on the vehicle model under consideration and its features (by way of example, consideration may be given here that K=0.01327 l·km⁻¹).

To take into account the electric current consumption of the auxiliary devices, a second step of correcting each reference curve CEᵢ as a function of the electric power Pₐᵤₓ consumed by these auxiliary devices is provided.

It will be noted here that the electric power value Pₐᵤₓ under consideration is the value that may be measured at the time of the calculations. In this method, the assumption is therefore made that the consumed electric power will remain substantially constant during the route. If the computer were ever to detect a large variation in this electric power over a long duration (for example because the air conditioning is turned on), it could be programmed to restart the method at this step so as to take into account the new electric power value Pₐᵤₓ.

More precisely, the method could be reset to this second correction step if the difference between the electric power under consideration in the calculations and the measured electric power were to remain greater than a threshold (for example of 10%) over a duration greater than a threshold (for example 5 minutes).

As shown clearly in FIG. 6, the second correction step consists simply in shifting the reference curve CEᵢ associated with the section Tᵢ to the left (that is to say with constant fuel consumption), by a value dependent on the electric power Pₐᵤₓ.

Specifically, it is understood that when the electrical devices are used, the charging of the battery will be slower than predicted and the discharging of this battery will be faster than predicted.

In practice, the correction step will consist in shifting the reference curve CEⱼ by a value E_{AUX} calculated from the following formula:

$${E}_{AUX} = \frac{{P}_{AUX}}{\overline{v}} \qquad [ 3 ]$$

where v̅ represents the average speed over the section (in km/h). This value may be supplied directly by the geolocation and navigation system, by estimating that it will be equal to the value of the speed of the traffic or to the statistical average speed or to the permitted speed limit.

The invention aims to propose an energy management system (EMS) capable of limiting the ageing of the traction battery, in particular when the total energy required to reach the final destination of the hybrid vehicle is far greater than the electrical energy contained in the traction battery. In this case, a large portion of the energy required to reach the final destination is thermal, and the traction battery makes it possible to save a small portion of this energy. In view of this small energy saving, it is therefore preferable to preserve the state of health (SOH) of the traction battery, by promoting use thereof in optimum usage conditions.

Specifically, for one and the same supply voltage delivered by the traction battery, the value of the electric current that it generates varies depending on its state of charge (SOC). Thus, the value of the current generated by the traction battery may be very low or else very high, when its charge is respectively high or low. In these precise cases, the components of the battery are subject to excessively slow or excessively fast dynamics, causing premature wearing of its components. To prevent this premature ageing phenomenon, battery manufacturers recommend ranges of optimum usage values for the battery, between a minimum threshold (SOE_{min′}, for example 60% charge) and a maximum threshold (SOE_{max′}, for example 80% charge) for the charge of the traction battery, between a minimum state of charge value (SOEₘᵢₙ, for example 10% charge) and a maximum state of charge value (SOEₘₐₓ, for example 90% charge) during use thereof.

The invention aims precisely to promote operation of the traction battery in its range of optimum usage values and for as long as possible, during the route of the hybrid vehicle, while at the same time providing for complete discharge thereof at the final destination of the vehicle. The term “complete discharge” is understood to mean that the charge of the battery is lower than a resting charge value. By way of example, this resting charge value may be less than 10% or less than 5% of its capacity of the total charge of the traction battery. The resting charge value preferably corresponds to the recommendations of the manufacturer of the battery in relation to its optimum empty storage conditions.

The invention therefore proposes to use an algorithm for optimizing the energy management system of the hybrid vehicle, promoting use of the traction battery in its range of optimum usage values [SOE_{min′}, SOE_{max′}] for each section covered by the vehicle, and complete discharge of the traction battery at the end of its route.

The optimization algorithm is implemented by the computer in a fifth step of the method described above, which, as it is recalled, consists in determining an optimum point Pᵢ of each reference curve CEⱼ selected for each section of the route.

More precisely, the optimization algorithm aims first of all to minimize, at the start of each section to be covered, the value of an energy cost function ƒ, so that the energy consumption is as low as possible over the entire route.

This energy cost function ƒ corresponds to the sum of the energy consumed by the vehicle to reach a new section i and an estimation of the energy to be used to reach the final destination corresponding to a section N.

More precisely, the energy cost function ƒ is defined as follows:

ƒ(dᵢ,SOEᵢ)=g(dᵢ,SOEᵢ)+h(d_{(i,N)},SOE_{(i,N)}) [4]

where:
the function g(dᵢ,SOEᵢ) represents the overall energy cost SOEᵢ to cover the distance dᵢ so as to reach the node i from an initial node (corresponding to the start of the route), and passing through all of the previous nodes; and
the function h(d_{(i,N)},SOE_{(i,N)}) represents an estimation of the remaining energy cost SOE_{(i,N)} to cover the remaining distance d_{(i,N)} to reach the final node N (corresponding to the final destination) from the node i.

The calculation of values of the function ƒ at the start of each section i therefore involves calculating the value of the functions g(dᵢ,SOEᵢ) and h(d_{(i,N)},SOE_{(i,N)}) defined as follows:

g(dᵢ,SOEᵢ)=g(dᵢ₋₁,SOEᵢ₋₁)+M_{FC}ⁱ⁻¹(ΔSOE_{(i-1,i)}×lᵢ₋₁ [5]

and

h(d_{(i,N)},SOE_{(i,N)})=Σⱼ₌ᵢ^{N}M_{FC}^{j}(ΔSOE_{(i,j)})×lⱼ [6]

where:
lᵢ is the length of the section i;
ΔSOE_{(i-1,i)} is the variation in the state of charge of the traction battery over the section preceding the node i;
M_{FC}ⁱ is the fuel consumption of the hybrid vehicle over the section preceding the node i.

To facilitate the reader's understanding of the invention, FIG. 8 shows an example of calculations of values of the energy cost function ƒ by the computer. More precisely, in FIG. 8, the route of the hybrid vehicle is divided into N sections up to its final destination, symbolized by the letter T. Each section is characterized by a specific distance lᵢ plotted on the abscissa axis. The ordinate axis indicates the state of charge (SOE) of the traction battery along the route. In the present example, the hybrid vehicle approaches a second section (i=2) of its journey. The computer then calculates the value of the function of the energy cost ƒ by varying the value of the function h, more precisely by varying the value of the fuel consumption required to reach the final destination of the route, according to the variation in the state of charge of the traction battery. In the present example, five values of the function h are calculated, making it possible to obtain five values of the function ƒ that are plotted, in FIG. 8, on an axis delineating the first and the second section. Of course, the computer may perform a greater or smaller number of calculations of values of the function ƒ.

As a reminder, the invention aims to limit the ageing of the traction battery, in particular when the energy required to reach the final destination of the vehicle is far greater than the electrical energy available in the traction battery. To this end, the invention proposes to weight the fuel consumption values used in equations [5] and [6], with a preservation value (rₚᵣₑ) for preserving the state of health (SOH) of the traction battery.

The aim of this weighting is overall to create a situation whereby each node of the route is chosen not only depending on the energy consumption of the vehicle over the entire route, but also such that, when the route is long and the contribution from the electric traction chain will be negligible, the burdens that are exerted on the battery, and that are such that they will age it, remain limited.

The fuel consumption values are more precisely weighted as follows:

M_{FC}ⁱ(ΔSOE_{(x,y)},S̅O̅E̅_̅{̅(̅x̅,̅y̅)̅}̅,Rₓ)=rₚᵣₑ(ΔSOE_{(x,y)},S̅O̅E̅_̅{̅(̅x̅,̅y̅)̅}̅,Rₓ)×m_{FC}ⁱ(ΔSOE_{(x,y)}) [7]

where:
ΔSOE_{(x,y)} represents the variation in the state of charge of the traction battery per kilometer traveled, in the section delineated by the nodes x and y;
S̅O̅E̅_̅{̅(̅x̅,̅y̅)̅}̅ represents the average value of the state of charge of the traction battery between the nodes x and y;
Rₓ represents the distance between the node x and the final node N; and
m_{FC}ⁱ represents the function as defined in equation [1] above for the node i.

The preservation relationship (rₚᵣₑ) depends on the following parameters:

rₚᵣₑ(ΔSOE_{(x,y)},S̅O̅E̅_̅{̅(̅x̅,̅y̅)̅}̅,Rₓ)=1−ƒ_{act}(Rₓ)×ƒ_{pond}(S̅O̅E̅_̅{̅(̅x̅,̅y̅)̅}̅−SOE_{rec})×Pₘₐₓ [8]

where:
ƒ_{act}(Rₓ) represents an activation function, where Rₓ is the distance to be covered by the hybrid vehicle to reach its final destination;
ƒₚₒₙ(S̅O̅E̅_̅{̅(̅x̅,̅y̅)̅}̅−SOE_{rec}) represents a weighting function;
SOE_{rec} represents the median value of the recommended range of optimum usage values of the traction battery, where:

$${SOE}_{rec} = \frac{{SOE}_{{max}^{′}} + {SOE}_{{min}^{′}}}{2} ;$$

pₘₐₓ represents a maximum weighting value.

In particular, the range of optimum usage values of the traction battery depends on the type of the battery and the recommendations of its manufacturer. By way of example, this range of optimum usage values of the traction battery may be between 60% and 80% of its maximum electric charge. Of course, these values may vary depending on the intrinsic characteristics of the battery that is used.

The activation function f_{act} depends on the distance R_{T} that the motor vehicle has to cover before reaching its final destination. The activation function aims to make it possible to apply a significant weighting (that is to say a significant weight) to the fuel consumption value m_{fc} when the vehicle is located at a distance that is still far from its final destination, and to then reduce this weight so as to allow complete discharging of the battery once it has arrived at its destination.

To this end, the following distance thresholds may be defined:
Rₘᵢₙ representing the minimum distance below which no weighting is applied (f_{fac}(Rₓ)=0 where R_{T}<Rₘᵢₙ), by way of example the value of Rₘᵢₙ may correspond to twice the maximum electrical autonomy of the vehicle in kilometers (l_{AER});
Rₘₐₓ representing the distance beyond which 100% of the weighting is applied (f_{fac}(Rₓ)=1 where R_{T}>Rₘₐₓ), by way of example the value of Rₘₐₓ may correspond to six times the maximum electrical autonomy of the vehicle in kilometers (AER).

It should be noted that the weighting function may vary linearly between the values Rₘᵢₙ and Rₘₐₓ, as shown in FIG. 9. Of course, other variation profiles are possible.

The weighting function fₚₒₙ depends firstly on the average value of the state of charge of the traction battery between the nodes x and y; and secondly on the value SOF_{rec} representing the median value of the recommended SOE interval in the optimum usage range of the traction battery. This weighting function thus aims to create a situation whereby the state of energy SOE remains in the optimum usage range for as long as possible (for as long as the vehicle is far from the arrival point of the route). By way of example, the weighting function may be defined so as to reproduce one or the other of the traces (I) and (II) shown in FIG. 10. Of course, other trace profiles are possible.

The maximum weighting value pₘₐₓ defines the maximum degree of weighting of the nodes with a state of energy SOE in the optimum usage range. By way of example, the maximum weighting value may be equal to 0.1 so as to promote 10% of the nodes in the optimum usage range.

The use of the weighting relationship described above thus makes it possible to modify the calculated values of the energy cost function ƒ, such that the optimization algorithm then gives priority to the values corresponding to a fuel consumption that makes it possible to discharge or recharge the traction battery, such that its state of charge is within its range of optimum usage values for as long as possible during the route, and to ensure complete discharging of the traction battery at the end of the route. Thus, in the present example, the value of the function ƒ is minimized by the weighting relationship such that its calculated values are as low as possible in the middle of the interval of the optimum usage range of the traction battery, corresponding for example to the value 3 in FIG. 8.

Depending on the minimum value of the function ƒ determined by the optimization algorithm, the computer deduces from this an optimum point (Pᵢ) on the reference curve CEᵢ associated with the section Tᵢ, making it possible to promote use of the traction battery in its range of optimum usage values.

In a sixth step of the method described above, once the optimum path has been found (passing through the optimum points of the reference curves CEⱼ), the computer formulates an energy management setpoint as a function of the coordinates of the optimum points Pᵢ. This energy management setpoint is then used during the route by the computer so as to monitor the trajectory.

Numerous methods allow such monitoring to be performed. One example is in particular clearly illustrated in patent application FR2988674 filed by the applicant, or else in documents WO2013150206 and WO2014001707.

FIG. 11 shows an example of an energy management setpoint according to the invention, for a route of around 800 km on an expressway, with the scenario of a hybrid vehicle having a maximum electrical autonomy l_{AER} of 30 km. The curve A illustrates an energy management setpoint using a discharge-hold strategy, known from the prior art, in comparison with an energy management setpoint according to the invention shown by the curve B. In this example, the invention makes it possible to increase the distance during which the traction battery operates in its optimum usage range by more than 600%, this distance changing from 10 km to 600 km. In addition, the invention makes it possible to ensure complete discharging of the traction battery at the end of the route, thereby maximizing the use of the electrical potential of the vehicle and making it possible to reduce fuel consumption.

The present invention is in no way limited to the embodiment that is described and shown, but a person skilled in the art will know how to add any variant thereto in accordance with its spirit.

In particular, rather than storing the parameters ψ₀, ψ₁, ψ₂, ΔSOEₘᵢₙ, ΔSOEₘₐₓ of the reference curves, there may be provision for the computer to store points that globally characterize the form of each reference curve. Reference will then be made to cartography.

According to another variant of the invention, if the geolocation and navigation system does not know the value of an attribute of a section of the route, there may be provision:
either for the calculation of the probability sums not to take into account the values of the probabilities assigned to this attribute,
or for the calculation to replace the unknown value with a predetermined value.

In conclusion, the invention proposes a novel method for calculating setpoints for managing the fuel consumption and electric current consumption of a hybrid motor vehicle, reducing the ageing of the traction battery during routes greater than its maximum electrical autonomy, while ensuring that the traction battery is discharged when the hybrid vehicle arrives at its final destination. In other words, the invention proposes an optimization algorithm comprising a weighting function that penalizes the fuel consumption calculations when the battery is not operating in its optimum operating state, while at the same time ensuring that the state of energy of the battery reaches a recommended minimum threshold when the vehicle arrives at the destination.

1-10. (canceled)

11. A method for optimizing energy consumption of a hybrid vehicle comprising an internal combustion engine supplied with fuel and an electric engine supplied by a traction battery, the method comprising:
a) acquiring, by way of a navigation system, a route to be taken;
b) dividing said route into successive sections;
c) acquiring, for each of the sections, attributes characterizing said section;
d) for each of said sections, and taking into account the attributes of the section, selecting, from among a plurality of predetermined relationships linking values of fuel consumption with values of electrical energy consumption, a relationship linking the fuel consumption of the hybrid vehicle over the section to an electrical energy consumption;
e) determining an optimum point for preserving the state of health of the traction battery in each of the selected relationships, such that all of the optimum points minimize ageing of the traction battery over the entire route and maximize the discharge of the traction battery at the end of said route; and
f) formulating a setpoint for managing the fuel consumption and electric current consumption of the hybrid vehicle, along the entire route, as a function of the coordinates of said optimum points.

12. The method for optimizing the energy consumption of the hybrid vehicle as claimed in claim 11, wherein, in step e), the determination of the optimum point in each of the relationships selected for each section depends on the fuel consumption over the entire section, weighted by a preservation relationship for preserving the state of health of the traction battery.

13. The method for optimizing the energy consumption of the hybrid vehicle as claimed in claim 12, wherein the value of the preservation relationship decreases when the state of energy of the traction battery is within an optimum usage range.

14. The method for optimizing the energy consumption of the hybrid vehicle as claimed in claim 12, wherein the value of the preservation relationship decreases when the distance to be covered to arrive at the destination increases.

15. The method for optimizing the energy consumption of the hybrid vehicle as claimed in claim 12, wherein the preservation relationship depends on a product of an activation function and a weighting function, the value of the activation function being at a minimum when the remaining distance to be covered is less than a first threshold that is determined on the basis of a maximum electrical autonomy of the vehicle, so as to minimize the influence of the preservation relationship in the determination of the optimum point.

16. The method for optimizing the energy consumption of the hybrid vehicle as claimed in claim 12, wherein the preservation relationship depends on a product of an activation function and a weighting function, the value of the weighting function being at a minimum when the state of energy of the traction battery is outside of an optimum usage range, so as to minimize the influence of the preservation relationship in the determination of the optimum point.

17. The method for optimizing the energy consumption of the hybrid vehicle as claimed in claim 15, wherein the value of the activation function is at a maximum when the distance to be covered to arrive at the destination decreases.

18. The method for optimizing the energy consumption of the hybrid vehicle as claimed in claim 15, wherein the value of the weighting function is at a maximum when the state of energy of the traction battery is in a center of an optimum usage range.

19. The method for optimizing the energy consumption of the hybrid vehicle as claimed in claim 15, wherein the weighting function has a maximum value over more than 10% of an optimum usage range of the traction battery.

20. The method for optimizing the energy consumption of the hybrid vehicle as claimed in claim 13, wherein the optimum usage range of the traction battery is between 60% and 80%.
